(19) United States
(12) Patent Application Publication
(10) Pub. No.: US 2010/0169602 A1
(43) Pub. Date: Jul. 1, 2010

(54) Method and Apparatus for Efficient Memory Placement

(76) Inventors: Jared E Hulbert, Shingle Springs, CA (US); Hongyu Wang, Shanghai (CN); John C Rudelic, Folsom, CA (US); August Camber, Rocklin, CA (US); Edward Patriquin, Sacramento, CA (US)

Correspondence Address: LEMOINE PATENT SERVICES, PLLC, PO BOX 307, LONG LAKE, MN, 55356-0307, US

(21) Appl. No.: 12/433,763

(22) Filed: Apr. 30, 2009

Related U.S. Application Data
(63) Continuation-in-part of application No. 12/345,306, filed on Dec. 29, 2008.

(51) Int. Cl. G06F 12/00

(52) U.S. Cl. 711/165; 711/E12.001

(57) ABSTRACT

A memory profiling system profiles memory objects in various memory devices and identifies memory objects as candidates to be moved to a more efficient memory device. Memory object profiles include historical read frequency, write frequency, and execution frequency. The memory object profile is compared to parameters describing read and write performance of memory types to determine candidate memory types for relocating memory objects. Memory objects with high execution frequency may be given preference when relocating to higher performance memory devices.

### RELATED APPLICATIONS

Benefit is claimed under 35 U.S.C. 120 as a Continuation-in-Part (CIP) of U.S. application Ser. No. 12/345,306, entitled “A Method and Apparatus to Profile RAM Memory Objects for Displacement With Nonvolatile Memory” by Rudelic et al., filed Dec. 29, 2008, which is incorporated herein in its entirety by reference for all purposes.

### FIELD

The present invention relates generally to data storage in memory devices, and more specifically to determining types of memory devices to use for data storage.

### BACKGROUND

Many computer architectures structure memory as either (1) primary memory, which is volatile (meaning that the information is lost when the memory has no power), but relatively fast, such as random access memory (RAM), or (2) secondary memory, which is nonvolatile, but relatively slow, such as FLASH memory and a hard disk. As small inexpensive computers (e.g., cell phones, smartphones, media players) become more feature packed, the desire for increased memory resources has also grown. One simple solution is to add more RAM to the system, but this increases cost. Another simple solution is to add more nonvolatile memory. This is cheaper, but is generally lower performance (slower).

### BRIEF DESCRIPTION OF THE DRAWINGS

Embodiments of the invention are illustrated by way of example and not limitation in the figures of the accompanying drawings, in which like references indicate similar elements and in which:

FIG. 1 shows a memory profiling system in accordance with various embodiments of the invention;

FIG. 2 illustrates a block diagram of a memory profiling system in accordance with various embodiments of the invention; and

FIGS. 3-6 are flow diagrams of methods in accordance with various embodiments of the present invention.

### DESCRIPTION OF EMBODIMENTS

Embodiments of the invention provide a method and system for profiling memory objects that reside in different types of memory devices. For example, the read, write, and execution frequency of memory objects held in volatile memory (e.g., RAM and DRAM) may be profiled. Also for example, the read, write, and execution frequency of memory objects held in nonvolatile memory (e.g., FLASH and PCM) may be profiled. As a result of profiling, memory objects may be identified as candidates to be relocated to and accessed directly from other types of memory devices in an electronic system.

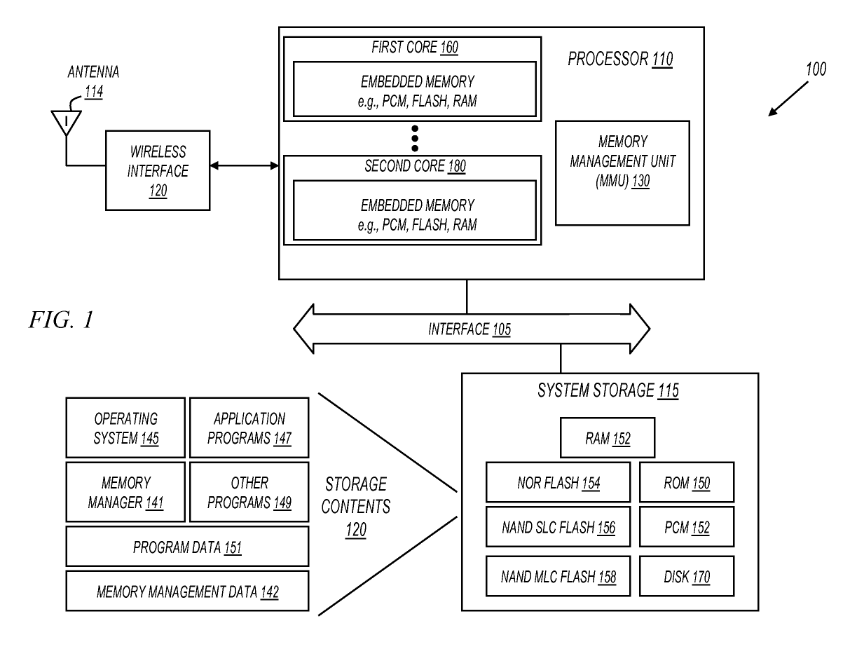

FIG. 1 shows a system 100 in accordance with various embodiments of the invention. System 100 may be a device useful for memory profiling. System 100 may also be an end-user device. In some embodiments, system 100 is both an end-user device and a device capable of performing memory profiling. For example, system 100 may be a mobile phone with built-in memory profiling capabilities. Also for example, system 100 may be a global positioning system (GPS) receiver or a portable media player with built-in memory profiling capabilities. System 100 may be any type of device without departing from the scope of the present invention.

In some embodiments, system 100 has a wireless interface 120. Wireless interface 120 is coupled to antenna 140 to allow system 100 to communicate with other over-the-air communication devices. As such, system 100 may operate as a cellular device or a device that operates in wireless networks such as, for example, Wireless Fidelity (Wi-Fi) that provides the underlying technology of Wireless Local Area Network (WLAN) based on the IEEE 802.11 specifications, WiMax and Mobile WiMax based on IEEE 802.16-2005, Wideband Code Division Multiple Access (WCDMA), and Global System for Mobile Communications (GSM) networks, although the present invention is not limited to operate in only these networks. It should be understood that the scope of the present invention is not limited by the types of, the number of, or the frequency of the communication protocols that may be used by system 100. Embodiments are not, however, limited to wireless communication embodiments. Other non-wireless applications can use the various embodiments of the invention.

System 100 includes processor 110 coupled to interface 105. Interface 105 provides communication between processor 110 and the storage devices in system storage 115. Interface 105 can include serial and/or parallel buses to share information along with control signal lines to be used to provide handshaking between processor 110 and the various storage devices within system storage 115.

System storage 115 may include one or more different types of memory and may include both volatile (e.g., random access memory (RAM) 152) and nonvolatile memory (e.g., read only memory (ROM) 150, phase change memory (PCM) 152, NOR FLASH memory 154, NAND single level cell (SLC) memory 156, NAND multi-level cell (MLC) memory 158, and disk 170). These memory types are listed as examples, and this list is not meant to be exclusive. For example, some embodiments may include Ovonic Unified Memory (OUM), Chalcogenide Random Access Memory (C-RAM), Magnetic Random Access Memory (MRAM), Ferroelectric Random Access Memory (FRAM), Static Random Access Memory (SRAM), Dynamic Random Access Memory (DRAM), or any other type of storage device.

Different memory types have different read and write performance, and also have different costs per bit of storage. For example, RAM may have very high (fast) read and write performance, while MLC NAND FLASH may have very low (slow) read and write performance. RAM also tends to be more expensive than MLC NAND FLASH. Table 1 shows relative performance parameters for various memory types on a scale from one to ten.

TABLE 1

| | Read | Write |
|---|---|---|
| Memory Device Type | Performance | Performance |
| Tightly Coupled Memory (TCM) | 10 | 10 |
| Random Access Memory | 9 | 9 |
| (RAM) | | |
| Compressed Random Access | 9 | 8 |
| Memory (CRAM) | | |
| Phase Change Memory (PCM) | 9 | 5 |
| NOR Nonvolatile Memory | 7 | 2 |
| (NOR) | | |
| NAND Nonvolatile Memory | 3 | 4 |
| (NAND), Single Level Cell (SLC) | | |
| NAND Nonvolatile Memory | 2 | 2 |
| (NAND), Multiple Level Cell | | |
| (MLC) | | |
| Disk, Magnetic or Optical | 1 | 1 |

The performance parameters shown in Table 1 are shown as examples, and may vary considerably based on many factors. For example, manufacturers using different processes produce parts of various speeds, as well as “bin” parts with various speed grades. Also for example, design artifacts such as buffer placement and bus speeds may affect performance. Accordingly, the performance parameters in Table 1 may have any value without departing from the scope of the present invention.

Various embodiments of the present invention provide for efficient use of cheaper, lower performance memory device types. For example, as described more fully below, memory objects are profiled to determine their relative read frequency, write frequency, and execution frequency. If an object is rarely read or written, then the object may be efficiently stored in an inexpensive memory type with low read and write performance. If an object is read often, but written less often, it may be a good candidate to reside in relatively inexpensive PCM memory, which has very good read performance, but lesser write performance. In some embodiments, an object that includes executable code that is executed often may be given preference to reside in a memory with very good read performance.

System storage 115 provides storage for storage contents 120. Storage contents 120 may include operating system 145, application programs 147, memory manager 141, other programs 149, program data 151, and memory management data 142. One skilled in the art will appreciate that storage contents 120 may include anything that can be represented in a digital format, including any type of program, instructions, or data.

Different parts of storage contents 120 can be stored in different types of memories within system storage 115. For example, memory manager 141 may be stored in RAM 152, while program data 151 may be stored in NOR FLASH 154. In some embodiments, each component within storage contents 120 may be spread across multiple types of memory within system storage 115. For example, part of memory manager 141 may be stored in RAM 152, while another part of memory manager 141 may be stored in ROM 150, while still another part of memory manager 141 may be stored in PCM 152. In general, any and all of storage contents 120 may be spread among the different types of memory within system storage 115.

Memory manager 141 profiles read, write, and execution behavior of various parts of storage contents 120, and resulting profile data can be kept in memory management data 142. For example, memory manager 141 may monitor read operations and write operations to a particular memory page physically located in any type of memory within system storage 115. Also for example, memory manager 141 may monitor whether a read operation will also result in code being executed by processor 110. As a result, memory manager 141 produces memory management data 142 that includes read rankings, write rankings, and execution rankings describing relative frequencies of read, write, and code execution operations for the memory page. This memory management data is then used to determine the type of memory within which to store the page of data. In some embodiments, memory manager 141 performs this profiling for all pages, and in other embodiments, memory manager 141 performs this profiling for less than all pages. As described further below with reference to later figures, memory manager 141 may also move portions of storage contents 120 between memory types to better match content profiles with memory types.

Processor 110 includes at least one core 160, 180, and each core may include memory. For example, first core 160 may include volatile or nonvolatile memory such as PCM, FLASH, or RAM. Each core may include any combination of different types of memory without departing from the scope of the present invention. The memory included in processor cores is referred to herein as tightly coupled memory (TCM). The cores can generally read and write fastest to TCM.

Processor 110 may execute instructions from any suitable memory within system 100. For example, any of the memory devices within system storage 115 may be considered a computer-readable medium that has instructions stored that when accessed cause processor 110 to perform embodiments of the invention

Processor 110 also includes an integral memory management unit (MMU) 130. In some embodiments, MMU 130 is a separate device. Memory management unit 130 is a hardware device or circuit that is responsible for handling accesses to memory requested by processor 110. Memory management unit 130 supports virtual memory and paging by translating virtual addresses into physical addresses. Memory management unit 130 divides the virtual address space (the range of addresses used by the process) into pages, each having a size which is a power of 2 (i.e., 2N). The bottom N bits of the address (the offset within a page) are left unchanged. The upper address bits are the virtual page number.

Memory management unit 130 includes a small amount of memory (e.g., cache) that holds a table to translate virtual page numbers to physical page numbers. The table may be referred to as a translation look aside buffer (TLB) that matches virtual memory addresses to physical memory addresses. All requests for data are sent to MMU 130, which determines whether the data is addressable using the existing contents of the TLB and/or page table. If a different physical memory page needs to be addressable, or if the data needs to be fetched from a mass storage device (e.g., a disk drive 170), MMU 130 issues a page fault interrupt.

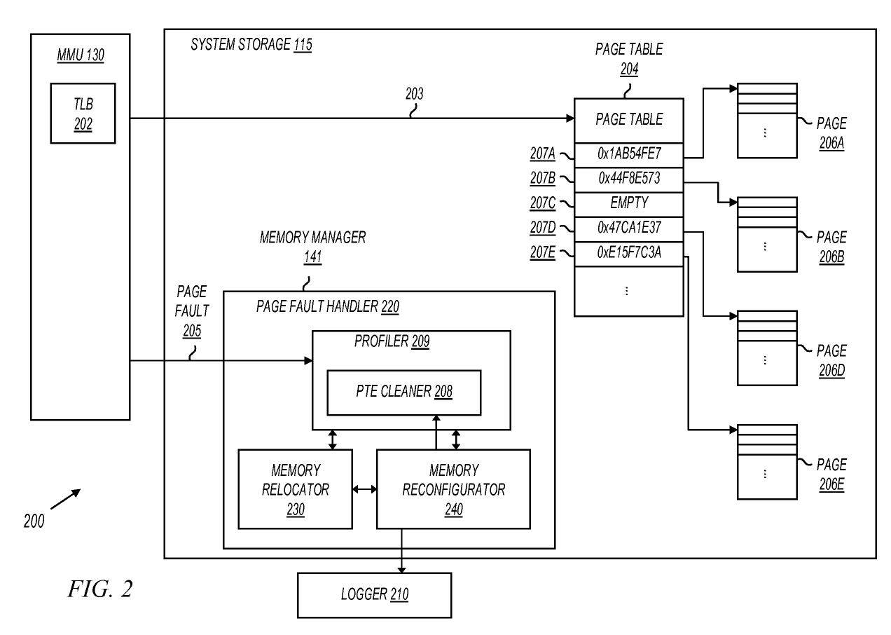

FIG. 2 illustrates a block diagram of a memory profiling system 200 in accordance with various embodiments of the invention. System 200 is shown including MMU 130 and system storage 115, however system 200 may include many more system elements such as processors and wireless interfaces. System storage 115 is shown holding various storage contents. For example, the storage contents within system storage 115 include memory manager 141, page table 204, and various pages of memory 206. Each of these storage content elements may be stored in any type of memory within system storage 115. For example, all or a portion of memory manager 141 may be stored in RAM. Also for example, various memory pages 206 may be spread among different types of volatile and nonvolatile memory.

System 200 uses a page-type virtual address scheme and includes memory manager 141 to profile memory objects and to relocate memory objects between various memory types. All requests for data are sent to the MMU 130, which determines whether a memory object is addressable via a page table entry in page table 204. A memory object has a virtual address including a virtual page number and an offset with the page number. If possible, MMU 130 translates virtual page numbers to physical page numbers via a translation look aside buffer 202 (TLB). For example, if a program is running and tries to access a memory object, MMU 130 looks up the address within TLB 202. If MMU 130 detects a match for the virtual page within TLB 202 (a TLB hit), the physical location is retrieved and the program can access the memory object. However, TLB 202 may hold a fixed number of page translations and if TLB 202 lacks a translation (a TLB miss), MMU 130 accesses 203 page table 204, a mechanism involving hardware-specific data structures.

Page table 204 contains page table entries (PTEs) 207A-E, where each entry identifies a physical location of a page (206A, 206B, 206D, or 206E). Page table 204 may be stored in RAM, however this is not a limitation of the present invention. For example, page table 204 may be stored in a nonvolatile memory such as FLASH or PCM. Pages are defined-length contiguous portions of memory and may store any type of data. The page table entries 207A-E can also include information about whether the page (memory object) has been written to, when it was last accessed, what kind of processes may read and write it, and whether it should be cached.

If MMU 130 does not find a valid entry for the virtual address in the page table 204, MMU 130 generates a processor interrupt called a page fault 205 interrupt (or page fault). For instance, when access to a memory object is requested, if MMU 130 finds there is no translation in page table 204 (e.g., 207C) for the memory page within which the memory object resides, MMU 130 generates a page fault 205. When a page fault 205 occurs, MMU 130 transfers control to page fault handler 220.

Page fault handler 220 decides how to handle a page fault 205. Page fault handler 220 determines whether the virtual address is valid. If the virtual address is valid, in some embodiments, page fault handler 220 finds an available page in RAM, places the memory object in that page, and updates page table 204 with the translation. In other embodiments, the memory object is not copied into an available page in RAM. Instead, page table 204 is updated to point directly to the memory object in its current storage location. For example, a memory object may be stored in PCM memory. When a page fault occurs, instead of copying the memory object from the PCM memory into RAM and updating the page table to point to the RAM page, the page table may be updated to point to the memory object in PCM memory. Once the page table is updated to make the memory object addressable, page fault handler 220 instructs MMU 130 to retry the operation. MMU 130 retries the operation and the page (memory object) is accessed regardless of its physical location.

Page fault handler 220 includes profiler 209 to profile memory objects. Profiler 209 uses the page faults 205 to monitor the page table activity to generate profiling data for determining whether a memory object is a candidate to be relocated to a different memory type. Profiling data can include the address of the memory object, how often an object is read, and how often the object is written to. In some embodiments, profiling data may also include how often an object is executed from its current location. For example, if a memory object is accessed because it includes software code to be executed, this information may be logged in addition to the read logging.

Profiler 209 compiles the profiling data that describes the relative read frequency and write frequency of memory objects. Example profiling data is shown in Table 2. This data may be stored as memory management data 142 (FIG. 1). Table 2 shows “n” memory objects having profile data. Any number of memory objects may be profiled.

TABLE 2

| | Read | Write | Execution |
|---|---|---|---|
| Memory Object | Frequency | Frequency | Frequency |
| Memory Object 1 | 9 | 9 | 0 |
| Memory Object 2 | 3 | 3 | 0 |
| Memory Object 3 | 1 | 1 | 1 |
| Memory Object 4 | 7 | 3 | 6 |
| . | | | |
| . | | | |
| . | | | |
| Memory Object n | 7 | 4 | 0 |

In some embodiments, profiler 209 determines profile data by monitoring the page table activity for a period of time (profiling time period). The write frequency is the number of times a memory object was written to during the profiling time period (normalized to ten). The read frequency is the number of times a memory object was read during the profiling time period (normalized to ten). The execution frequency is the number of times code from the memory object was executed during the profiling time period (normalized to ten). Profiler 209 determines a memory object's read, write, and execution frequency by logging a page fault 206 for a memory object each time a memory object is accessed during the profiling time period. In some embodiments, profiler 209 includes a page table entry (PTE) cleaner 208 to clean the page table entries of a page table. When a page is accessed, PTE cleaner 208 marks the page table entry as invalid. In some embodiments, PTE cleaner 208 periodically marks page table entries as invalid at a predefined time interval (e.g., 10 ms). Marking page table entries as invalid artificially “cleans” page table 204 and forces a page fault when the same memory object is next requested. Profiler 209 detects the page fault and determines whether the memory object is being accessed for a write operation, a read operation, and/or an execution operation. In this manner, profiler 209 is able to log the number of times each profiled memory object is written, read, and executed.

For example, system 200 illustrates PAGE 206A and PAGE 206B. Profiler 209 determines that PAGE 206A was accessed a single time and had no write activity performed on it. Therefore, profiler 209 logs a single read operation for PAGE 206A. Profiler also determines whether the read operation for PAGE 206A was for executable code, and if so, a single execution operation is logged. The page table entry for PAGE 206A may be invalidated after each log entry so that a page fault will again be generated when PAGE 206A is accessed. Profiler 209 determines that PAGE 206B was accessed a single time and written to one time during the profiling time period. Therefore, the profiler 209 logs a single write operation for PAGE 206B. The page table entry for PAGE 206B may be invalidated after each log entry so that a page fault will again be generated when PAGE 206B is accessed.

Profiler 209 can output profile data as a raw data file that includes hex or binary information. In some embodiments, a logger 210 receives the profiler 209 output, creates a new memory map (e.g., memory configuration file), and automatically rebuilds the system memory according to the new memory map. In these embodiments, logger 210 compares the profile data with the memory type parameters (see Table 1), and determines candidate memory types suitable to store each memory object. For example, logger 210 may determine that NAND SLC memory is a candidate memory type to store memory object 2 (Table 2) because the parameters for NAND SLC in this example (3, 4; Table 1) closely match the profile data of memory object 2 (3, 3; Table 2).

In some embodiments, pages (e.g., 206A-206E) are compressed before they are stored in either nonvolatile or volatile memory (e.g., FLASH, PCM, RAM). In these embodiments, as a page is requested, an operating system will read a page out of the compressed image stored in memory, decompress it, and copy the decompressed page into a memory device from which it will be accessed (e.g., FLASH, PCM, RAM). If the page is accessed often, the operating system may leave an uncompressed image available for direct access. In other embodiments, the operating system may compress a memory object and store it as a compressed object. In these embodiments, the object may be decompressed as needed when accessed.

In some embodiments, logger 210 formats the profiling data generated by profiler 209 into a format a user is able to use to manually change a system's memory map and manually rebuild the system memory. Logger 210 receives the profiler output and maps it back to the specific pages (e.g., a particular data object, a particular file, a particular executable image, a particular database file, etc. and the offset within that file). The format may be a histogram that can illustrate which pages were frequently accessed and which pages were rarely accessed. A user can manually change a system's memory map and manually rebuild the system memory based on the data provided in the histogram.

In some embodiments, system 200 includes a memory reconfigurator 240 to dynamically reconfigure the system memory. Using the output of profiler 209, memory reconfigurator 240 identifies candidate memory types for each profiled memory page, and provides the information (e.g., new memory map) to a memory relocator 230. Memory relocator 230 uses the new memory map to relocate memory pages in memory devices of the candidate memory type, and interacts with page fault handler 220 to make memory objects available directly from their new locations according to the new memory map.

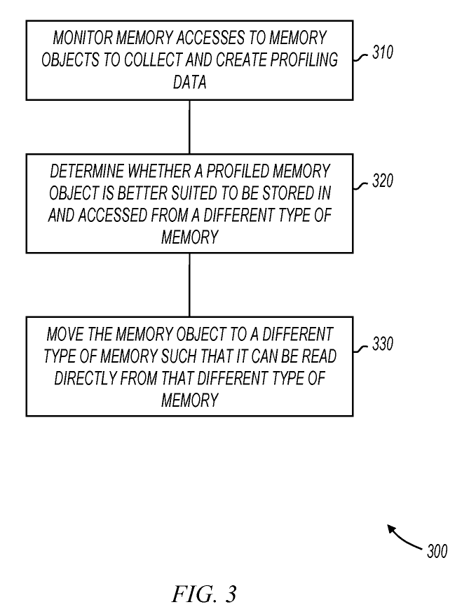

FIG. 3 is a flow diagram of a method in accordance with various embodiments of the present invention. The method may be performed by processing logic that may comprise hardware (e.g., circuitry, dedicated logic, etc.), software (such as run on a general purpose computer system or a dedicated machine), or a combination of both. In some embodiments, the processing logic resides in a memory profiling system 100 of FIG. 1.

At block 310, processing logic monitors memory accesses to memory objects to collect and create profiling data. Profiling data may include the address of the memory object, how often the memory object is read, how often the object is written to, and/or how often any code in the object is actually executed. At block 320, processing logic uses the profiling data to determine whether a profiled memory object is better suited to be stored in and accessed from a different type of memory. For example, a memory object currently stored in NAND SLC FLASH may be better suited to be stored in PCM. Also for example, a memory object stored in either volatile or nonvolatile memory may be betters suited to be stored on a disk or vice versa. At block 330, processing logic moves the memory object to a different type of memory such it can be read directly from that different type of memory. In some embodiments, this corresponds to memory relocator 230 (FIG. 2) relocating a page of memory.

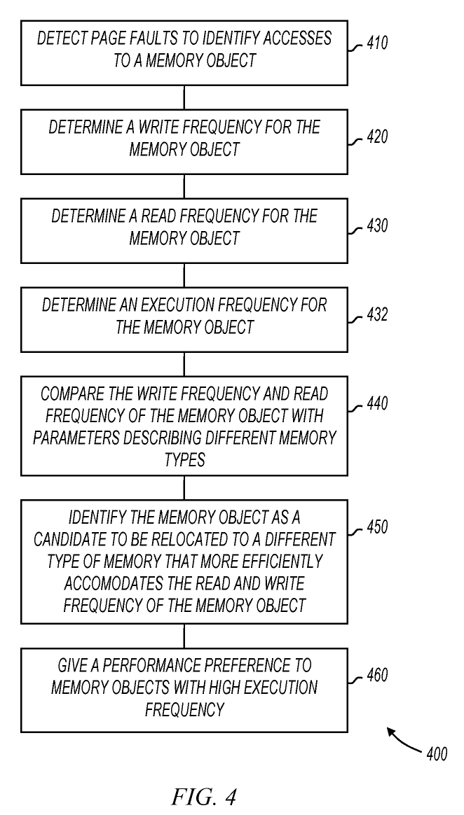

FIG. 4 is a flow diagram of a method in accordance with various embodiments of the present invention. The method can be performed by processing logic that includes, but is not limited to hardware (e.g., circuitry, dedicated logic, etc.), software (such as run on a general purpose computer system or a dedicated machine), or a combination of both. In some embodiments, the processing logic resides in a memory profiling system 100 of FIG. 1.

At block 410, processing logic detects page faults and uses the page faults to identify memory objects that are being accessed. The processing logic detects a page fault by monitoring the activity of a page table for a period of time or profiling time. The profiling time may be a pre-defined time period or a user-defined time period. For example, an OEM may run tests for a two-hour time period and therefore, processing logic monitors a page table's activity for a two-hour time period. The processing logic can identify the object by an address.

At block 420, processing logic determines a write frequency for a memory object, at block 430, the processing logic determines a read frequency for the memory object, and at block 432, the processing logic determines an execution frequency for the memory object. The write frequency is the number of times a memory object is written during the profiling period, the read frequency is the number of times the memory object is read during the profiling period, and the execution frequency is the number of times executable code is executed from the memory object during the profiling period. In the examples provided herein, the write, read, and execution frequencies are normalized to ten, but this is not a limitation of the present invention.

At block 440, the write frequency and the read frequency of the memory object are compared with parameters describing different memory types. For example, the entries of Table 2 above may be compared with the entries of Table 1 above. At block 450, the memory object is identified as a candidate to be relocated to a different type of memory that more efficiently accommodates the read and write frequency of the profiled memory object. In some embodiments, the memory object is moved as part of the operations in block 450, and in other embodiments, the resulting data is stored, so that the memory map may be rebuilt offline.

In some embodiments, the parameters describing the different memory types are stored in the system storage, so that method 400 may be performed in an end user device while in operation. For example, a cellular phone may have memory type parameters stored as memory management data 142 (FIG. 1) in a nonvolatile memory, and method 400 may be performed periodically by the cell phone to make more efficient use of the available system storage.

In some embodiments, method 400 (at 460) gives a performance preference to memory objects that include executable code. For example, if two memory objects (one having executable code, and one not) have similar read/write frequencies, the memory object with executable code may be given preference when relocating to higher performance memory devices.

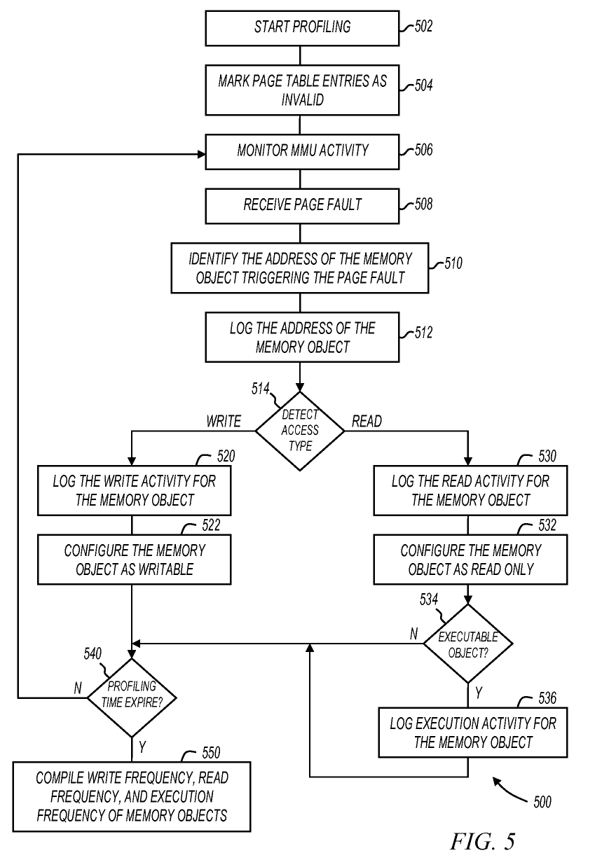

FIG. 5 is a flow diagram of a method in accordance with various embodiments of the present invention. Method 500 may be performed by processing logic that may comprise hardware (e.g., circuitry, dedicated logic, etc.), software (such as run on a general purpose computer system or a dedicated machine), or a combination of both. In some embodiments, the processing logic resides in a memory profiling system 100 of FIG. 1. For example, method 500 may be performed by processor 110 while executing page fault handler 220 (FIG. 2).

At block 502, profiling is started. In some embodiments, profiling occurs periodically for a specified period of time. For example, an OEM can define processing logic to perform profiling for 2 ms every 10 ms. In these embodiments, a timer may be reset or started at 502, and the profiling may occur for the time period specified by the timer. At block 504, page table entries are marked as invalid to cause page faults for subsequent memory access.

At block 506, processing logic monitors a page table's activity. At block 508, a page fault is received because of a memory access. At 510, processing logic identifies the address of the memory object triggering the page fault at block 508. At block 512, processing logic logs the address of the memory object. Alternatively, processing logic can determine the memory object was previously accessed during the profiling period and therefore already logged.

At block 514, processing logic detects the access type as either a read or a write. If a read access, then processing logic logs the read activity for the memory object at 530 and configures the memory object as read only at 532. In some embodiments, the operations at block 532 include updating a page table entry to point to a memory page in one of many various types of memory. For example, the memory object being accessed may reside in a PCM memory. If so, “configuring” the memory object includes updating the page table entry so that the memory object can be accessed directly from PCM memory. If the access is a read, then processing logic determines if executable code is being accessed at 534. If executable code is being accessed, then processing logic logs the execution activity for the memory object at 536.

If a write access, then processing logic logs the write activity for the memory object at 520 and configures the memory object as writable at 522. In some embodiments, the operations at block 522 include updating a page table entry to point to a memory page in one of many various types of memory. For example, the memory object being accessed may reside in a PCM memory. If so, “configuring” the memory object includes updating the page table entry so that the memory object can be accessed directly from PCM memory.

At block 540, if processing logic determines the profiling time period has not expired, processing logic returns to block 506 to continue monitoring the page table activity. If processing logic determines the profiling time has expired (block 540), processing logic compiles the write frequency, read frequency, and execution frequency of profiled memory objects (550) from the number of read, write, and execution operations performed.

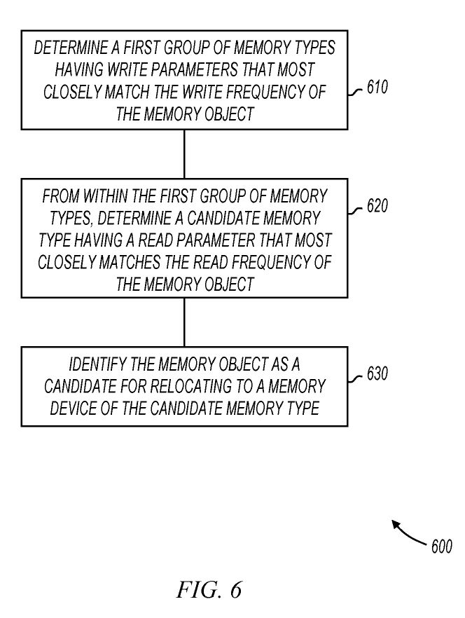

FIG. 6 is a flow diagram of a method in accordance with various embodiments of the present invention. Method 600 may be performed by processing logic that may comprise hardware (e.g., circuitry, dedicated logic, etc.), software (such as run on a general purpose computer system or a dedicated machine), or a combination of both. In some embodiments, the processing logic resides in a memory profiling system 100 of FIG. 1. For example, method 600 may be performed by processor 110 when executing memory reconfigurator 240 and/or memory relocator 230.

At block 610, processing logic determines a first group of memory types having write parameters that most closely match the write frequency of a memory object. The result is a list of memory types that would be suitable to accommodate the historical write frequency of the memory object. At 620, processing logic determines, from within the first group of memory types, a candidate memory type having a read parameter that most closely matches the read frequency of the memory object. The candidate memory type represents the memory type with read/write performance parameters that most closely match the read and write history of the memory object.

At block 630, processing logic identifies the memory object as a candidate for relocating to a memory device of the candidate memory type. In some embodiments, method 600 continues on to relocate the memory object to a memory device of the candidate memory type, and in other embodiments, method 600 logs the identity of the candidate memory object and the candidate memory type for offline memory map processing.

In some embodiments, candidate memory types are determined using different methods. For example, a table of memory types may be addressed using read and write frequency profile data. The table is organized such that the most closely matching memory type is identified for each address in the table. In other embodiments, a two dimensional correlation is performed to determine the most closely matching memory types. Any method to compare profile data with memory type parameters may be utilized without departing from the scope of the present invention.

An algorithm is herein, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. All of these and similar terms are to be associated with the appropriate physical quantities and are merely convenient labels applied to these quantities.

Unless specifically stated otherwise, as apparent from the preceding discussions, it is appreciated that throughout the specification discussions utilizing terms such as “monitoring,” “storing,” “detecting,” “using,” “identifying,” “marking,” “receiving,” “loading,” “reconfiguring,” “formatting,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

Various general purpose systems may be used with programs in accordance with the teachings herein, or it may prove convenient to construct a more specialized apparatus to perform the desired method. The desired structure for a variety of these systems appears in the description above. In addition, embodiments of the invention are not described with reference to any particular programming language. A variety of programming languages may be used to implement the teachings of the invention as described herein. In addition, it should be understood that operations, capabilities, and features described herein may be implemented with any combination of hardware (discrete or integrated circuits) and software.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A method comprising:
profiling read frequency and write frequency of a memory object;
comparing the read frequency and write frequency of the memory object to parameters describing different memory types to determine a candidate memory type; and
identifying the memory object as a candidate to be relocated to a memory device of the candidate memory type.

2. The method of claim 1 further comprising relocating the memory object to the memory device of the candidate memory type.

3. The method of claim 2 wherein relocating the memory object includes moving the memory object from a volatile memory device to a nonvolatile memory device.

4. The method of claim 2 wherein relocating the memory object includes moving the memory object from a nonvolatile memory device to a volatile memory device.

5. The method of claim 2 wherein relocating the memory object includes rebuilding a system memory map that allows the memory object to be accessed directly from the memory device of the candidate memory type.

6. The method of claim 5 wherein relocating the memory object further includes storing the memory object as an uncompressed memory object.

7. The method of claim 5 wherein relocating the memory object further includes storing the memory object as a compressed memory object.

8. The method of claim 1 wherein comparing the read frequency and write frequency of the memory object to parameters describing different memory types to determine a candidate memory type comprises:
determining a first group of memory types having write parameters that most closely match the write frequency of the memory object; and
from within the first group of memory types, determining the candidate memory type having a read parameter that most closely matches the read frequency of the memory object.

9. The method of claim 1 wherein profiling comprises:
monitoring page table activity;
receiving a page fault;
detecting read, write, or execute activity; and
compiling write frequency, read frequency, and execute frequency of the memory objects.

10. A machine-accessible medium having instructions stored thereon that when accessed result in the machine performing:
monitoring page table activity in a virtual memory system; and
logging profiling data describing read frequency and write frequency of a memory page, the profiling data to be used to determine whether the memory page should be relocated to a different memory type.

11. The machine-accessible medium of claim 10 wherein the instructions when accessed further result in the machine performing:
detecting a page fault; and
determining if a profiling period has expired.

12. The machine-accessible medium of claim 10 wherein the instructions when accessed further result in the machine performing relocating the memory page to a disk.

13. The machine-accessible medium of claim 10 wherein the instructions when accessed further result in the machine performing:
determining a candidate memory type that matches the read frequency and the write frequency of the memory page.

14. A system comprising:
a processor;
a plurality of memory devices of different types; and
a memory manager to profile read frequency and write frequency of memory objects and to determine whether the memory objects would be better suited to reside in different ones of the plurality of memory devices.

15. The system of claim 14 wherein the memory manager further profiles execution frequencies of the memory objects.

16. The system of claim 15 further comprising a logger to produce a log of the read, write, and execute frequencies of the memory objects.

17. The system of claim 15 wherein the memory manager includes a page fault handler to detect read operations, write operations, and code executions when page faults occur.

18. The system of claim 14 wherein the memory manager includes a memory relocator to relocate memory objects.

19. The system of claim 14 wherein the plurality of memory devices includes at least one phase change memory (PCM) device.

20. The system of claim 14 wherein the plurality of memory devices includes at least one FLASH memory device.
